(19) United States
(12) Patent Application Publication
(10) Pub. No.: US 2011/0100164 A1
(43) Pub. Date: May 5, 2011

(54) Self-Pulling Corkscrew

(75) Inventors: Alberto Mantilla, New York, NY (US); Anthony Baxter, Upper Montclair, NJ (US); Jason Liang, Fresh Meadows, NY (US); Thomas Hill, Charlotte, NC (US); Paul Elhardt, Charlotte, NC (US)

(73) Assignee: WKI HOLDING COMPANY, INC., Rosemont, IL (US)

(21) Appl. No.: 12/609,536

(22) Filed: Oct. 30, 2009

(51) Int. Cl. B67B 7/04

(52) U.S. Cl. 81/3.45

(57) ABSTRACT

A self-pulling corkscrew is provided. The corkscrew includes a body comprised of a first arm extending downwardly from a central portion and a second arm extending downwardly from the central portion. The first and second arms each having an inner surface and an outer surface wherein the inner surfaces of the first arm and the second arm cooperatively define a bottle receiving cavity. The corkscrew further includes a first groove traversing at least a portion of the outer surface of the first arm and a second groove traversing at least a portion of the outer surface of the second arm. One of either the first and second grooves has a first depth at a proximate end of the groove and a second depth at a distal end of the groove. The corkscrew is further comprised of a sleeve, a handgrip and a screw. The sleeve is slidably engaged with the first and second arms and has a first inwardly projecting protrusion and a second inwardly projecting protrusion. The first protrusion cooperatively engages the first groove and the second protrusion cooperatively engages the second groove. The handgrip is attached to the body proximate the central portion, and the screw is coupled to the handgrip. The screw extends into the bottle receiving cavity between the inner surfaces of the first and second arms.

### TECHNICAL FIELD

The present disclosure relates to a corkscrew, and more particularly, to a self-pulling corkscrew.

### BACKGROUND

Corkscrews are well-known implements for removing corks from beverage containers, such as wine bottles. Many different types of corkscrew designs and mechanisms have been employed over the years. For example, some corkscrews are comprised only of a screw attached to a simple handgrip. According to such designs, the screw is inserted into the cork and a user must rely on his or her strength to dislodge the cork from the bottle. Other designs employ one or more arms that are leveraged against the bottle to remove a cork, or that transfer rotation through gearing. Each of these corkscrew devices inherently requires a user to maintain a grip with one hand on both the bottle and the cork extracting device while the user's second hand operates the device. Thus, there is a need for a self-pulling corkscrew which does not require the use of one hand to hold both the bottle and the cork extracting device during operation.

The present corkscrew is provided to solve the problems discussed above and other problems, and to provide advantages and aspects not previously provided by cork extracting mechanisms such as corkscrews. A discussion of the present self-pulling corkscrew is deferred to the following detailed description, which proceeds with reference to the accompanying drawings.

### SUMMARY

According to one embodiment, a self-pulling corkscrew is provided. The corkscrew includes a body comprised of a first arm extending downwardly from a central portion and a second arm extending downwardly from the central portion. The first and second arms each have an inner surface and an outer surface wherein the inner surfaces of the first arm and the second arm cooperatively define a bottle receiving cavity. The corkscrew further includes a first groove traversing at least a portion of the outer surface of the first arm and a second groove traversing at least a portion of the outer surface of the second arm. One of either the first or second grooves has a first depth at a proximate end of the groove and a second depth at a distal end of the groove.

The corkscrew is further comprised of a sleeve, a handgrip and a screw. The sleeve is slidably engaged with the first and second arms and has a first inwardly projecting protrusion and a second inwardly projecting protrusion. The first protrusion cooperatively engages the first groove and the second protrusion cooperatively engages the second groove. The handgrip is attached to the body proximate the central portion, and the screw is coupled to the handgrip. The screw extends into the bottle receiving cavity between the inner surfaces of the first and second arms.

According to another embodiment, the corkscrew includes a body comprised of a first arm extending downwardly from a central portion and a second arm extending downwardly from the central portion. The first and second arms each have an inner surface and an outer surface wherein the inner surfaces of the first arm and the second arm cooperatively define a bottle receiving cavity. A first protrusion traverses at least a portion of the outer surface of the first arm and a second protrusion traverses at least a portion of the outer surface of the second arm. One or both of the first and second protrusions has a first height at a proximate end of the protrusion and a second height at a distal end of the protrusion.

The corkscrew is further comprised of a sleeve, a handgrip and a screw. The sleeve is slidably engaged with the first and second arms and has a first inwardly projecting protrusion and a second inwardly projecting protrusion. The first protrusion cooperatively engages the first groove and the second protrusion cooperatively engages the second groove. The handgrip is attached to the body proximate the central portion, and the screw is coupled to the handgrip. The screw extends into the bottle receiving cavity between the inner surfaces of the first and second arms.

According to still another embodiment, a self-pulling corkscrew is provided that includes a body comprised of a first arm extending downwardly from a central portion and a second arm extending downwardly from the central portion. The first and second arms each have an inner surface and an outer surface, wherein the inner surfaces of the first arm and the second arm cooperatively define a bottle receiving cavity. A recess is defined in the inner surfaces of the first and second arms. An inwardly projecting shoulder is disposed on the inner surface of each of the first and second arms proximate the recesses.

The corkscrew also includes a sleeve that is slidably engaged with the first and second arms. A handgrip is attached to the body proximate the central portion and a screw is coupled to the handgrip. The screw extends into the bottle receiving cavity between the inner surfaces of the first and second arms.

### BRIEF DESCRIPTION OF THE DRAWINGS

To understand the present corkscrew, it will now be described by way of example, with reference to the accompanying drawings in which:

FIG. 1 is a front view of one embodiment of a corkscrew according to the present disclosure.

FIG. 2 is a cross-sectional view of the corkscrew of FIG. 1.

FIG. 3 is an exploded perspective view of the corkscrew of FIG. 1.

FIG. 4 is a perspective view of the corkscrew of FIG. 1.

FIG. 5 is a front view of another embodiment of a corkscrew according to the present disclosure.

FIG. 6A is a cross-sectional view of the corkscrew of FIG. 5.

FIG. 6B is a top view of the sleeve of FIG. 6A.

The components in the drawings are not necessarily to scale, emphasis instead being placed upon clearly illustrating the principles of the present device.

### DETAILED DESCRIPTION

While this device is susceptible of embodiments in many different forms, there are shown in the drawings and will herein be described in detail preferred embodiments of the device with the understanding that the present disclosure is to be considered as an exemplification of the principles of the device and is not intended to limit the broad aspect of the device to the embodiments illustrated.

An apparatus for extracting a cork from a container is provided. According to the present disclosure, a user may engage the corkscrew 10 with a cork on a bottle or the like and employ the mechanisms described herein to stabilize the corkscrew 10 on a bottle in which this cork is secured. The corkscrew 10 is generally comprised of a body 12, a handgrip 50, a screw 52 and a sleeve 54.

As shown in FIGS. 1-6, the body 12 of the corkscrew 10 has a first arm 14 and a second arm 16. The first and second arms 14, 16 extend downwardly from a central portion 18 on the body 12. It will be understood by those of skill in the art that the central portion 18 of the body 12 and the first and second arms 14, 16 can be an integrally formed structure, or formed from separate structures. The first and second arms 14, 16 each have an inner surface 20, 22 and an outer surface 24, 26. The inner surface 20 of the first arm 14 and the inner surface 22 of the second arm 16 cooperatively define a bottle receiving cavity 28 between the arms 14, 16. In one embodiment, the inner surfaces 20, 22 of the first and second arms 14, 16 are defined by concave surfaces that accommodate one of several standard wine bottle neck sizes. However, it will be understood that the inner surfaces 20, 22 may conform to a container of any geometric or size configuration.

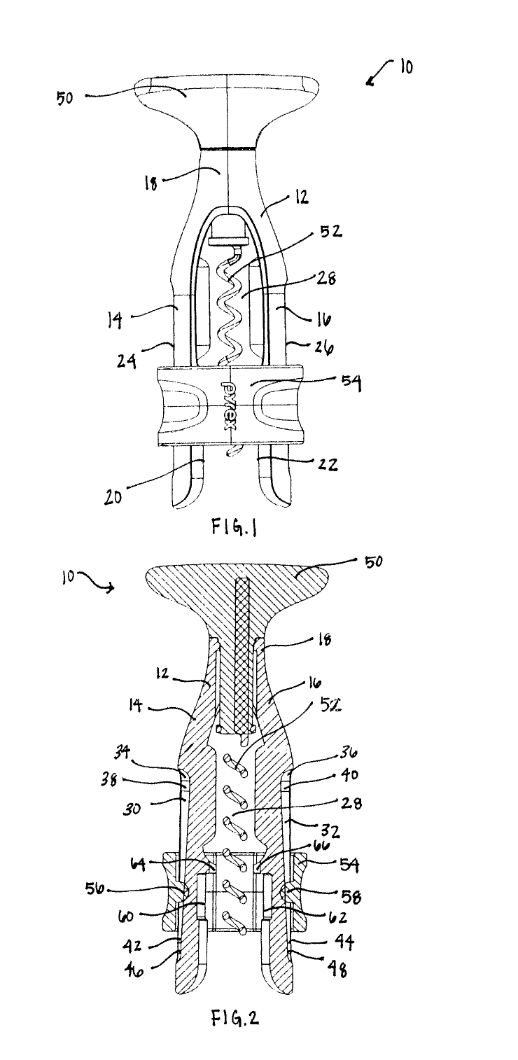

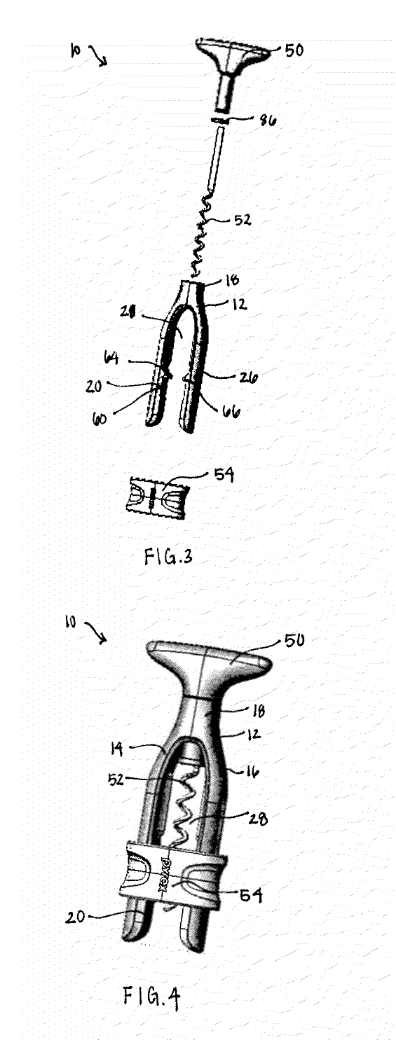

As shown in FIGS. 2-3, the first arm 14 of the present corkscrew 10 has a first groove 30 that traverses at least a portion of its outer surface 24. Similarly, the second arm 16 has a second groove 32 that traverses at least a portion of the outer surface 26 of the second arm 16. The first and second grooves 30, 32 each have a first depth 34, 36 at proximate ends 38, 40 of the respective grooves 30, 32, and a second depth 42, 44 at distal ends 46, 48 of the respective grooves 30, 32. The grooves 30, 32 are tapered such that the depth of each groove 30, 32 gradually decreases along the path of the respective groove 30, 32 from the proximate end 38, 40 to the distal end 46, 48. Accordingly, the first depth 34, 36 at the proximate end 38, 40 of each groove is greater than the second depth 42, 44 at the distal end 46, 48 of each groove.

As shown in FIGS. 1-4, the corkscrew 10 further includes a sleeve 54 that is slidably engaged with the first and second arms 14, 16. The sleeve 54 can be formed from plastic or any other material suitable for slidable engagement with the first and second arms 14, 16 of the present corkscrew 10. For example, the sleeve 54 may be formed from a flexible material such that it may offer some give when used with larger bottles. The sleeve 54 assists in centering and securing the corkscrew 10 over a container and cork.

The corkscrew 10 also includes a handgrip 50, which is attached proximate the central portion of the body 18. In one embodiment, the handgrip 50 will conform to optimal ergonomic principles to assist a user in easily grasping and rotating the handgrip 50 during use. As shown in FIGS. 2 and 3, the screw 52 is coupled to the handgrip 50 and extends into the bottle receiving cavity 28 between the inner surfaces 20, 22 of the first and second arms 14, 16. Rotation of the handgrip 50 transfers motion to the screw 52. It is contemplated that the handgrip 50 and the screw 52 can be either fixedly or removably coupled to one another. In one embodiment, the handgrip 50 is removably attached to the body 12 proximate the central portion 18 of the body 12 via a modified o-ring 86. Accordingly, it is contemplated that the o-ring 86 and the handgrip 50 can be removed from the body 12 so that the corkscrew 10 may be disassembled for ease of cleaning or storage.

The screw 52 used in connection with the corkscrew 10 described herein is preferably a worm screw of the type commonly employed in cork removers. However, it is contemplated that the screw 52 can assume any configuration suitable for use in extracting a cork from a container. It will also be understood that the screw 52 can be made of stainless steel, silver or any other material generally known to be used in connection with corkscrews.

According to one embodiment, the sleeve 54 includes a first inwardly projecting protrusion 56 and a second inwardly projecting protrusion 58. As shown in FIG. 2, the first protrusion 56 cooperatively engages the first groove 30 on the outer surface 24 of the first arm 14. The second protrusion 58 cooperatively engages the corresponding groove 32 on the outer surface 26 of the second arm 16. Thus, the grooves 30, 32 provide canted guides that constrain linear movement of the sleeve 54 along the arms 14, 16. It will be understood that stops may be formed in the proximate ends 38, 40 and distal ends 46, 48 of the grooves 30, 32 to assist in retaining engagement of the sleeve 54 with the arms 14, 16 of the corkscrew 10.

According to one embodiment shown in FIG. 2, the inner surface 20 of the first arm 14 and the inner surface 22 of the second arm 16 each include a recess 60, 62. The recesses 60, 62 are configured such that the recesses generally receive the top of a bottle or other container. In other words, when a bottle is inserted into the bottle receiving cavity 28, the recesses 60, 62 fit with the top of bottle. Many bottles having a cork, such as wine bottles, have a lip surrounding the top of the bottle. The recesses 60, 62 are formed such that the lip of the bottle is engaged by the recesses 60, 62.

As shown in FIG. 2, the inner surface 20, 22 of each of the arms 14, 16 also includes a respective inwardly projecting shoulder 64, 66. The shoulders 64, 66 are generally disposed proximate the recesses 60, 62 formed in the inner surfaces 20, 22 of the arms 14, 16. Preferably, the shoulders 64, 66 extend into the bottle receiving cavity 28 such that the shoulders 64, 66 are generally perpendicular to the inner surfaces 20, 22 of the first and second arms 14, 16. However, it will be understood that the shoulders 64, 66 do not need to be perpendicular to be subsumed by the contemplated corkscrew 10. Instead, the shoulders 64, 66 may extend inwardly at any angle suitable for stabilizing a bottle within the bottle receiving cavity 28 defined by the first and second arms 14, 16. Once a bottle is received and fit into the recesses 60, 62, the shoulders 64, 66 retard further insertion of the bottle into the receiving cavity 28. In one embodiment, the recesses 60, 62 and the shoulders 64, 66 secure the corkscrew 10 to the bottle.

In use, the handle 50 and screw 52 are turned counterclockwise such that the screw 52 is only partially extending into the bottle receiving cavity 28. The sleeve 54 is positioned around the arms 14, 16 of the body 12. The top of the bottle is inserted into the bottle receiving cavity 28, such that the arms 14, 16 are located positioned on the outsides of the top of the bottle. The bottle is inserted until the top of the bottle is engaged by the recesses 60, 62 and prevented from further insertion by the shoulders 64, 66. The sleeve 54 is adjusted by sliding it down along the length of the arms 14, 16. The handgrip 50 is rotated clockwise by a user such that the screw 52 engages the cork in the bottle. As the handgrip 50 is turned clockwise, the screw 52 further engages the cork and eventually begins to rise within the bottle receiving cavity 28 until the cork is completely extracted from the container.

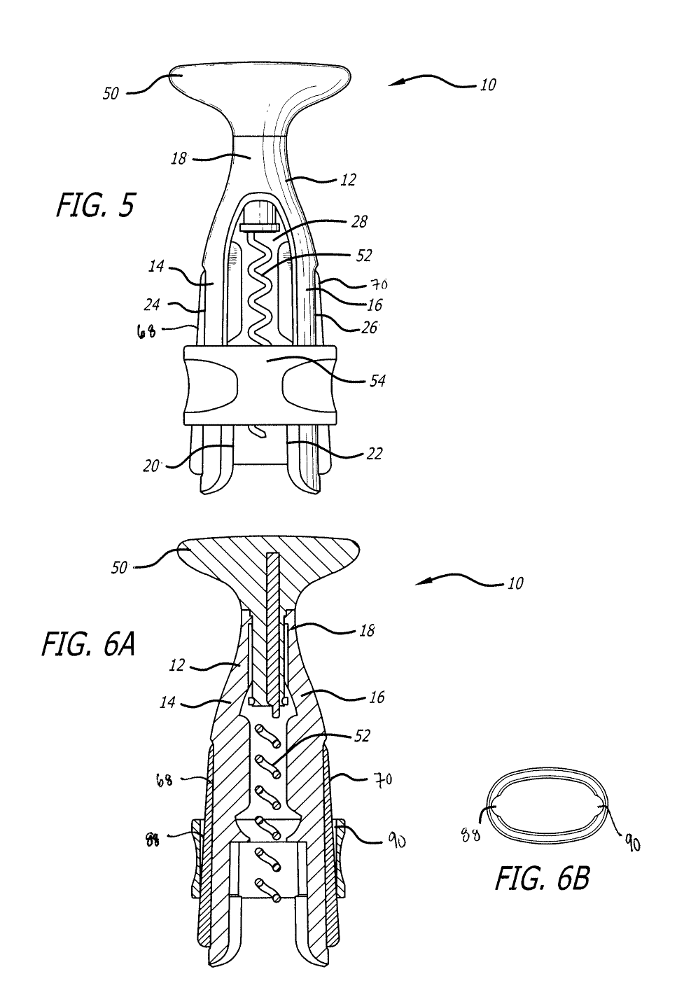

In another embodiment, shown in FIGS. 5, 6A and 6B, a first protrusion or rail 68 traverses at least a portion of the outer surface 24 of the first arm 14. Similarly, a second protrusion or rail 70 traverses at least a portion of the outer surface 26 of the second arm 16. According to this embodiment, one or both of the first and second protrusions or rails 68, 70 has a first height at a proximate end of the protrusion 68 and a second height at a distal end of the protrusion 70.

According to the embodiment shown in FIGS. 5 and 6A, the sleeve 54 has a first groove 88 disposed in an inner surface of the sleeve 54. The sleeve has a second groove 90 disposed in the inner surface of the sleeve 54. The first groove 88 cooperatively engages the first protrusion 68 and the second groove 90 cooperatively engages the second protrusion 70 of the respective first and second arms 14, 16.

Preferably, the protrusions or rails 68, 70 are tapered such that the height of at least one of the protrusions 68, 70 gradually increases along the path of that protrusion 68, 70 from the proximate end to the distal end. Accordingly, the height at the proximate end of the tapered protrusion 68, 70 is less than the height at the distal end of the tapered protrusion 68, 70.

While the specific embodiments have been illustrated and described, numerous modifications come to mind without significantly departing from the spirit of the present device, and the scope of protection is only limited by the scope of the accompanying Claims.

What is claimed is:

1. A self-pulling corkscrew comprising:
a body comprising a first arm extending downwardly from a central portion and a second arm extending downwardly from the central portion, the first and second arms each having an inner surface and an outer surface wherein the inner surfaces of the first arm and the second arm cooperatively define a bottle receiving cavity;
a first groove traversing at least a portion of the outer surface of the first arm and a second groove traversing at least a portion of the outer surface of the second arm, the first and second grooves each having a first depth at a proximate end of the groove and a second depth at a distal end of the groove;
a sleeve slidably engaged with the first and second arms, the sleeve having a first inwardly projecting protrusion and a second inwardly projecting protrusion, the first protrusion cooperatively engaging the first groove and the second protrusion cooperatively engaging the second groove;
a handgrip attached to the body proximate the central portion; and
a screw coupled to the handgrip and extending into the bottle receiving cavity between the inner surfaces of the first and second arms.

2. The self-pulling corkscrew of claim 1, wherein the first depth at the proximate end of each groove is greater than the second depth at the distal end of each groove.

3. The self-pulling corkscrew of claim 1, wherein the handgrip is removably attached to the body.

4. The self-pulling corkscrew of claim 1, wherein the sleeve is formed from a flexible polymer.

5. The self-pulling corkscrew of claim 1, further comprising a recess in each of the inner surfaces of the first and second arms.

6. The self-pulling corkscrew of claim 5, wherein each inner surface includes an inwardly projecting shoulder disposed on the inner surface of each of the first and second arms proximate the recess.

7. A self-pulling corkscrew comprising:
a body comprising a first arm extending downwardly from a central portion and a second arm extending downwardly from the central portion, the first and second arms each having an inner surface and an outer surface wherein the inner surfaces of the first arm and the second arm cooperatively define a bottle receiving cavity;
a first protrusion traversing at least a portion of the outer surface of the first arm and a second protrusion traversing at least a portion of the outer surface of the second arm, the first and second protrusions each having a first height at a proximate end of the protrusion and a second height at a distal end of the protrusion;
a sleeve slidably engaged with the first and second arms, the sleeve having a first groove disposed in an inner surface of the sleeve and a second groove disposed in the inner surface of the sleeve, the first groove cooperatively engaging the first protrusion and the second groove cooperatively engaging the second protrusion;
a handgrip attached to the body proximate the central portion; and
a screw coupled to the handgrip and extending into the bottle receiving cavity between the inner surfaces of the first and second arms.

8. The self-pulling corkscrew of claim 7, wherein the first height at the proximate end of each protrusion is less than the second height at the distal end of each protrusion.

9. The self-pulling corkscrew of claim 1, wherein the handgrip is removably attached to the body.

10. The self-pulling corkscrew of claim 1, wherein the sleeve is formed from a flexible polymer.

11. The self-pulling corkscrew of claim 1, further comprising a recess in each of the inner surfaces of the first and second arms.

12. The self-pulling corkscrew of claim 5, wherein each inner surface includes an inwardly projecting shoulder disposed on the inner surface of each of the first and second arms proximate the recess.

13. A self-pulling corkscrew comprising:
a body comprising a first arm extending downwardly from a central portion and a second arm extending downwardly from the central portion, the first and second arms each having an inner surface and an outer surface wherein the inner surfaces of the first arm and the second arm cooperatively define a bottle receiving cavity;
a recess defined in each of the inner surfaces of the first and second arms;
an inwardly projecting shoulder disposed on the inner surface of each of the first and second arms proximate the recess;
a sleeve slidably engaged with the first and second arms;
a handgrip attached to the body proximate the central portion; and
a screw coupled to the handgrip and extending into the bottle receiving cavity between the inner surfaces of the first and second arms.

14. The self-pulling corkscrew of claim 13, wherein the sleeve is formed from a flexible polymer.

15. The self-pulling corkscrew of claim 13, wherein the handgrip is removably attached proximate the central portion of the body.
